(19) United States
(12) Patent Application Publication
(10) Pub. No.: US 2006/0121852 A1
(43) Pub. Date: Jun. 8, 2006

(54) Portable apparatus

(75) Inventors: Young-Soo Kim, Goyang-si (KR); Beom-Ku Han, Seoul (KR); Chang-Hwan Hwang, Goyang-si (KR); Sung-Mo Chung, Seoul (KR); Jong-Seong Lee, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/260,708

(22) Filed: Oct. 27, 2005

(30) Foreign Application Priority Data
Dec. 3, 2004 (KR) P2004-101453
Mar. 24, 2005 (KR) P2005-24524

(51) Int. Cl. H04B 7/00

(52) U.S. Cl. 455/41.2

(57) ABSTRACT

A folding-type wireless handset has the usability of a folding-type portable apparatus and functions as an auxiliary portable apparatus of a portable apparatus having large horizontal and vertical dimensions, such as a PDA, using a short-distance communication means. The handset includes a handset body having a number of keys and a short-distance communication means; a handset folder having a display device; and a hinge device for rotatably connecting the handset body and the handset folder to each other. Dialing can be performed using the keys and bidirectional communication with a desired partner can be performed by transmitting and receiving signals between the body of a portable apparatus and the handset body using the short-distance communication means.

### PRIORITY

This application claims priority to an application entitled “Portable Apparatus” filed with the Korean Intellectual Property Office on Dec. 3, 2004 and assigned Serial No. 2004-101453 and an application entitled the same filed with the Korean Intellectual Property Office on Mar. 24, 2005 and assigned Serial No. 2005-24524, the contents of which are incorporated herein by reference.

### BACKGROUND OF THE INVENTION

1. Field of the Invention

The present invention relates to a portable apparatus, and more particularly to a portable apparatus having maximum user convenience.

2. Description of the Related Art

In general, a “portable apparatus” refers to an electronic apparatus that a user can carry to perform wireless communication with a desired partner. To facilitate portability, designs of such portable apparatuses tend not only to be compact, slim, and light, but are also moving toward providing multimedia availability, having a wider variety of functions. In particular, future portable apparatuses are expected to increasingly incorporate greater multi-functionality and be capable of multi-purpose utilization. The devices will continue to be even more compact, light, and capable of being modified to be suitable for various multimedia or Internet environments. Furthermore, these portable apparatuses are now commonly used by people of all ages and all walks of life throughout the world, and are recognized by many people as a nearly indispensable device which must be carried at all times.

Recently, a wireless data transmission mode has rapidly prevailed in outgoing access (OA) products, including computers and printers in homes and offices, based on the Bluetooth short-distance wireless access technology. In addition, transmission and reception handsets are widely used in information communication appliances, including portable apparatuses and Personal Digital Assistants (PDAs), for more convenient communication. It is expected that use of advanced information communication appliances using a short-distance wireless communication mode will be greatly expanded in the near future.

Conventional wireless headsets worn on a specific part of users' body, such as head or ears, can only transmit and receive voice communication relayed by the body of communication apparatuses. Therefore, conventional wireless headsets cannot be used to make phone calls or transmit text messages.

Conventional portable apparatuses may sometimes be worn on different parts of the user's body. However, even when worn on a specific part of the user's body, conventional portable apparatuses have limited usability and cannot provide users with maximized convenience.

### SUMMARY OF THE INVENTION

Accordingly, the present invention has been made to solve the above-mentioned problems occurring in the prior art. An object of the present invention is to provide a compact folding-type wireless handset for convenient use as an auxiliary terminal to a larger-sized portable apparatus, such as a PDA.

Another object of the present invention is to provide a folding-type wireless handset incorporating a data input function, such as text transmission, for better user convenience than conventional wireless handsets.

Another object of the present invention is to provide a folding-type handset pursuing compactness, lightness, and improved portability of a portable apparatus while overcoming inconvenient opening and closing operations caused by compactness.

Another object of the present invention is to provide a folding-type handset incorporating a data input function, such as text transmission, and a data output function, which makes it possible to check the output of inputted data, for text transmission and reception.

In order to accomplish these objects, there is provided an assembly of a portable apparatus and a wireless handset including a handset body having a number of keys and a short-distance communication means; a handset folder having a display device; and a hinge device for rotatably connecting the handset body and the handset folder to each other; wherein the assembly is adapted to perform dialing using the keys and bidirectional communication with a desired partner by transmitting and receiving signals between the body of the portable apparatus and the handset body using the short-distance communication means.

In accordance with another aspect of the present invention, an object of the present invention is to provide a portable apparatus adapted to be selectively opened and closed through a sliding or swing operation, while being worn around the user's neck, for maximized user convenience.

Another object of the present invention is to provide a portable apparatus adapted to be selectively used in a wired or wireless communication mode for maximum user convenience.

In order to accomplish these objects, there is provided a portable apparatus including a main housing; a sliding or swing housing adapted to slide or swing while continuously facing the main housing; a device for enabling a user to wear the main housing around his neck for wired or wireless communication; and at least one earphone connected to the device via a wire and adapted to be worn in the user's ear, wherein the portable apparatus is adapted to be selectively used in a short-distance wireless communication mode while being worn around the neck or in a wired communication mode while the earphone is worn in the ear.

### BRIEF DESCRIPTION OF THE DRAWINGS

The above and other objects, features, and advantages of the present invention will be more apparent from the following detailed description taken in conjunction with the accompanying drawings, in which:

FIG. 1 is a diagrammatic view showing the concept of using a portable apparatus according to a first embodiment of the present invention;

FIG. 2 is a perspective view showing a portable apparatus, when folded, according to a first embodiment of the present invention;

FIG. 3 is a perspective view showing a portable apparatus, when unfolded, according to a first embodiment of the present invention;

FIG. 4 is a front view of the portable apparatus shown in FIG. 2;

FIG. 5 is a bottom view of the portable apparatus shown in FIG. 2;

FIG. 6 is a lateral view of the portable apparatus shown in FIG. 2;

FIG. 7 is a front view showing the concept of using a portable apparatus according to a second embodiment of the present invention;

FIG. 8 is a front view showing a portable apparatus, while its housing is swung, according to a second embodiment of the present invention;

FIG. 9 is a front view showing a portable apparatus, after its housing is slid, according to a second embodiment of the present invention; and

FIG. 10 is a front view showing a portable apparatus, while its housing is swung, according to a second embodiment of the present invention.

### DETAILED DESCRIPTION OF THE PREFERRED EMBODIMENT

Hereinafter, a preferred embodiment of the present invention will be described with reference to the accompanying drawings. In the following description of the present invention, a detailed description of known functions and configurations incorporated herein is omitted to avoid making the subject matter of the present invention unclear.

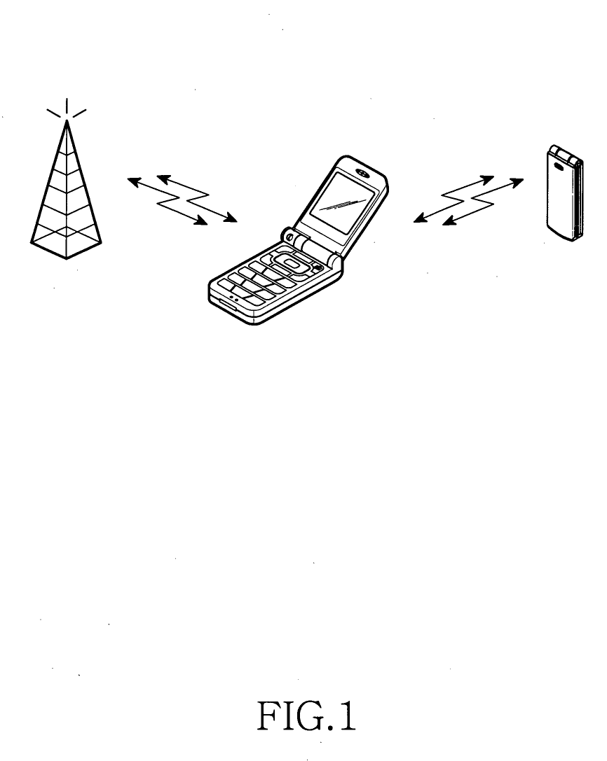

As shown in FIG. 1, a portable apparatus, particularly a wireless handset, according to a first embodiment of the present invention is a bidirectional auxiliary communication apparatus for transmitting and receiving signals with a smart phone having various functions, a portable appliance including a storage device (e.g., a hard disk), or a portable apparatus (for example, a PDA) having horizontal and vertical dimensions that are too large to be conveniently carried in a pocket of a user. Specifically, the inventive wireless handset can perform dialing (e.g., text transmission) with the body of a portable apparatus using keys, transmit and receive signals, and check a transmitted text using a display device. As such, the inventive handset incorporates the functions of voice communication and text message transmission of conventional folding-type portable apparatuses, so that the user can conveniently carry it and perform wireless communication with a desired partner.

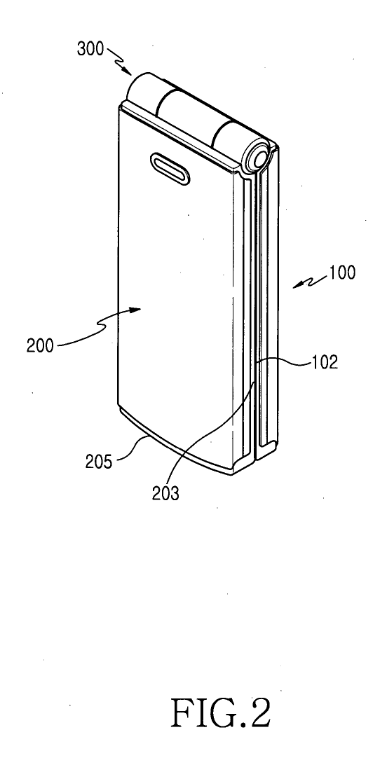

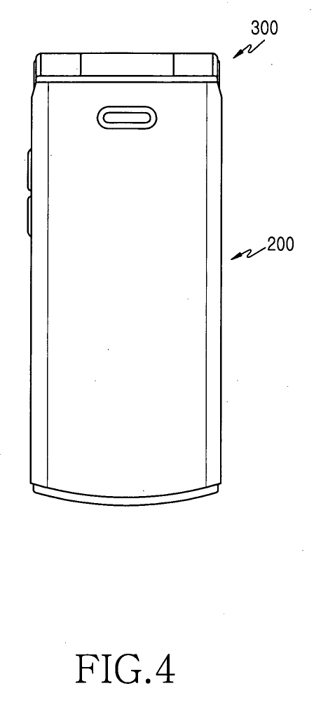

As shown in FIGS. 2 to 6, a folding-type handset according to the present invention includes a handset body 100 provided with a short-distance communication means for bidirectional data transmission and reception with the body of a PDA-type portable apparatus, a handset folder 200, and a hinge device 300 for connecting the handset folder 200 to the handset body 100 in such a manner that it can be rotated to fold on and unfold from the latter. The inventive handset has horizontal and vertical dimensions corresponding to those of a compact disposable cigarette lighter, not those of a PDA.

The handset body 100 has a number of keys 110 and a microphone device 112 positioned on the upper surface 101 thereof for text transmission through touch or key-pressing operations. The handset folder 200 has a speaker device 210 and a display device 212 positioned on the bottom surface 202 thereof to check transmitted data, which is displayed on the screen.

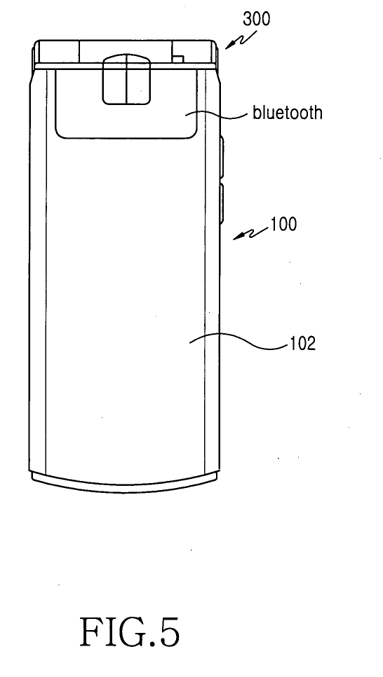

A conventional Bluetooth module is used for short-distance (1-10 m) wireless communication. Communication between the body (not shown) of the portable apparatus and the handset body 100, using Bluetooth is possible if the two devices are maintained in proximity. Bluetooth modules can rapidly synchronize information stored in desktop or laptop computers and are used as portable auxiliary terminals for faxes and printers in homes and offices. As shown in FIG. 5, the Bluetooth module is positioned on the bottom surface 102 of the handset body 100 while being adjacent to the hinge device 300.

The inventive handset has a size small enough to be carried and is used for data input and output operations or communication with a desired partner. The handset is used in a situation wherein only basic functions of a portable apparatus is necessary. A portable apparatus having a large size, such as a PDA or smart phone, is positioned within a short distance from the handset to permit communications between them. The portable apparatus may be carried in a bag of the user or in some other way so as to accommodate its larger size.

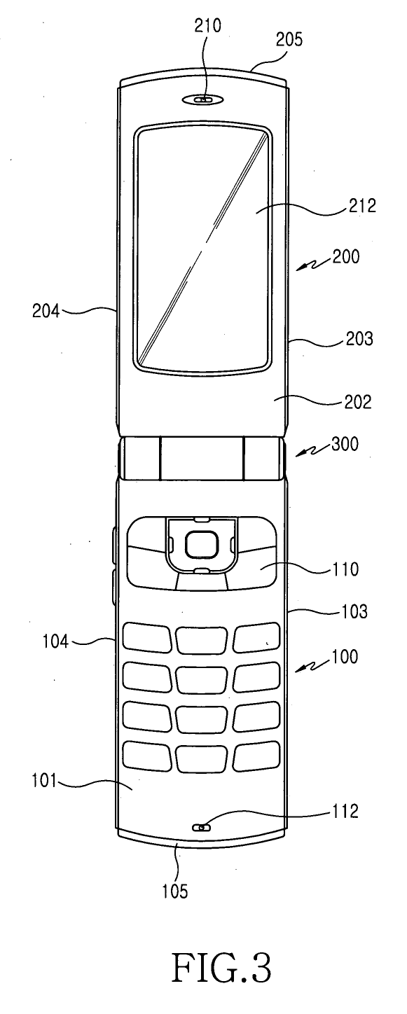

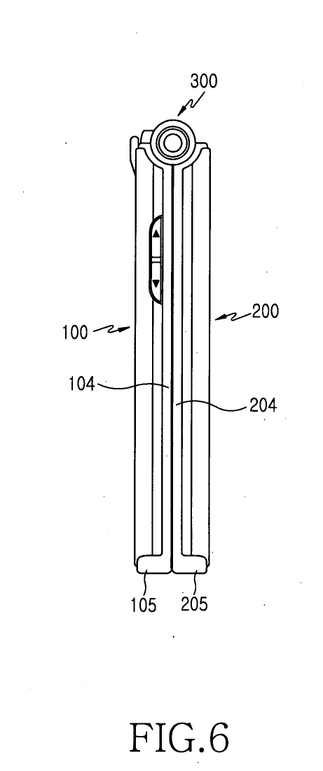

As shown in FIGS. 3 and 6, the inventive handset has a size corresponding to that of a disposable lighter. The handset includes first opening and closing grooves 103, 104, and 105 formed on the handset body 100 and second opening and closing grooves 203, 204, and 205 formed on the handset folder 200 for convenient opening and closing operations. The first opening and closing grooves 103, 104, and 105 are positioned on both lateral edges and the front edge of the handset body 100, respectively, and linearly extend in a continuous manner. The second opening and closing grooves 203, 204, and 205 are positioned on both lateral edges and the front edge of the handset folder 200, respectively, and linearly extend in a continuous manner. The first opening and closing grooves 103, 104, and 105 face the second opening and closing grooves 203, 204, and 205, respectively, when the handset folder 200 is completely folded on the handset body 100. The first and second opening and closing grooves are formed or positioned to be symmetric to each other.

The horizontal vs. vertical dimensional ratio of the handset body 100 is at least 1:2. In other words, the vertical length of the body 100 is at least two times larger than the horizontal length thereof. Similarly, the horizontal vs. vertical ratio of the handset folder 200 is at least 1:2.

In summary, the handset according to the present invention is compact and light to provide usability as a folding type handset. Therefore, the user can conveniently carry it and perform bidirectional communication, such as text transmission. In addition, the inventive handset has first and second opening and closing grooves 103, 104, 105, 203, 204, and 205 formed on the handset body 100 and the handset folder 200, respectively, to overcome inconvenient opening and closing operations caused by compactness.

The inventive handset can be used as an auxiliary apparatus, not only of a portable apparatus having a large overall size such as a PDA, but also for a portable apparatus having a very small overall size, such as a watch-type portable apparatus.

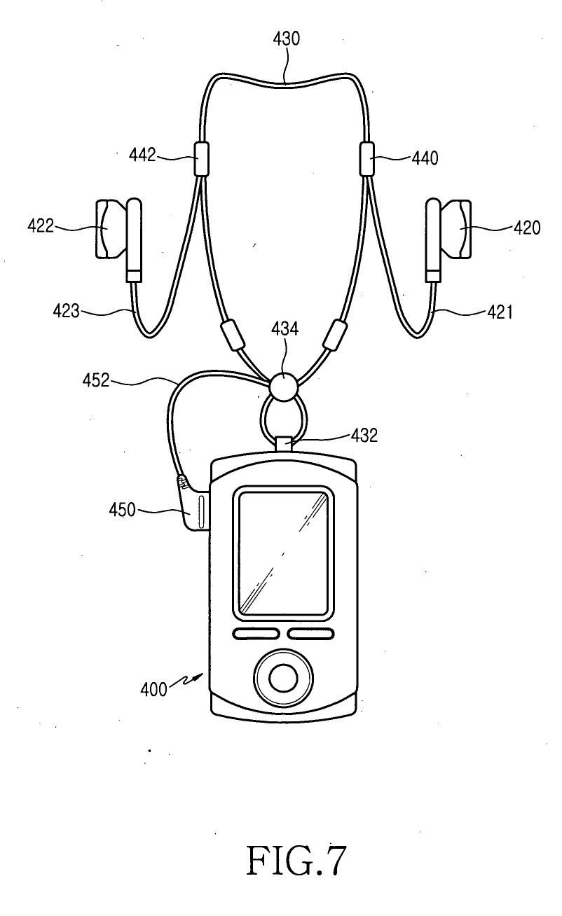

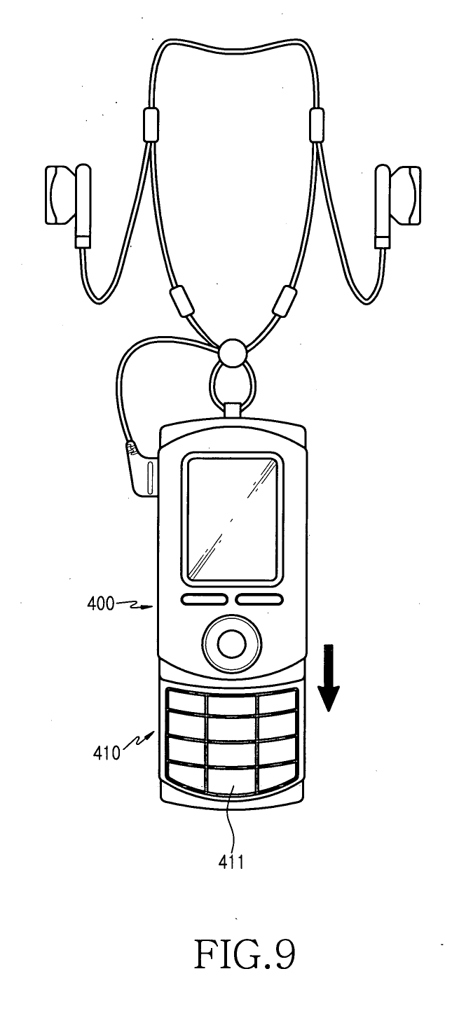

As shown in FIGS. 7 to 10, a portable apparatus, particularly a sliding or swing-type portable apparatus carried while being worn around the user's neck, according to a second embodiment of the present invention includes a main housing 400, a sliding or swing housing 410 adapted to selectively slide or swing while continuously facing the main housing 400, a wearing device for enabling the user to wear the main housing 400 around his neck, and at least one earphone 420 and 422 positioned between the wearing device and the main housing 400 to be worn in the user's ear. The user can open and close the portable apparatus in a sliding or swing mode and use it in a wireless or wired mode. In the wireless mode, a short-distance communication is performed using a Bluetooth module and, in the wired mode, signals are transmitted via wires.

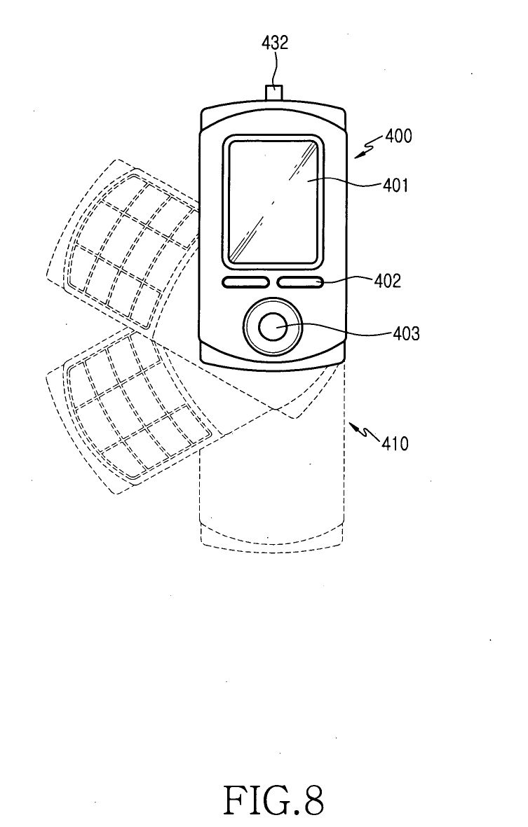

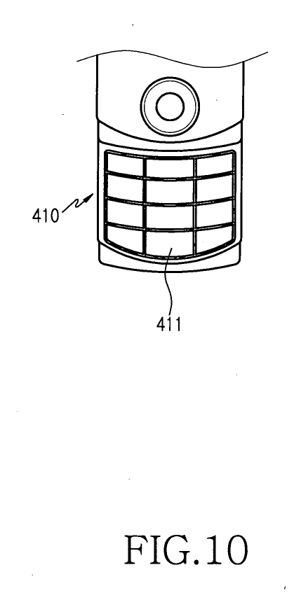

The sliding or swing housing 410 is adapted to slide or swing on the main housing 400 and the upper surface thereof is exposed or hidden by the main housing 400, accordingly. According to the user's choice, the sliding or swing housing 410 can slide along the longitudinal direction of the main housing 400 while being parallel to it, as shown in FIG. 10, and swing approximately 180° about a hinge axis positioned in the middle of the lower region of the main housing 400, as shown in FIG. 8.

As shown in FIG. 8, the main housing 400 has a display device 401, a normal key 402, and an MP3 key 403 successively positioned on the upper surface thereof. The MP3 key 403 is used in a music listening mode to select desired music. The MP3 key consists of a four-way key.

As shown in FIG. 7, the wearing device includes a first wire 430 for enabling the user to wear the portable apparatus around his neck, a pair of second wires 421 and 423 connected to the first wire 430, as well as to a pair of earphones 420 and 422, respectively, to transmit signals, a third wire 452 connected to the first wire 430 to transmit signals from the earphones 420 and 422, and a connector 450 positioned on an end of the third wire 452 and connected to the main housing 400.

At least one linear connection member 440 and 442 is positioned between the first wire 430 and each of the second wires 421 and 423. A spherical connection member 434 is positioned between the first wire 430 and the third wire 452. A metallic connection ring 432 is rotatably positioned on the upper end of the main housing 400 and is connected to the first wire.

In summary, the inventive portable apparatus is capable of being worn on a specific part of the user's body, particularly around the neck, to perform communication with a desired partner in a wired mode using earphones or by means of a short-distance communication means. This maximizes the user convenience. In addition, the portable apparatus can be selectively opened and closed through a sliding or swing motion, during communication with a partner, for more convenient use.

As mentioned above, the portable apparatus according to the present invention is used as an auxiliary portable apparatus of a portable appliance, such as a PDA, with improved portability and usability. The inventive portable apparatus can perform bidirectional data transmission and reception with the portable appliance and can be conveniently opened and closed despite its compactness. The portable apparatus can be selectively opened and closed through a sliding or swing operation, while being worn around the neck, and can be selectively used in a wired or wireless mode for the convenience of the user.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An assembly comprising:
a portable apparatus; and
a wireless handset, the wireless handset comprising a handset body having a plurality of keys and a short-distance communication means a handset folder having a display device; and a hinge device for rotatably connecting the handset body and the handset folder to each other,
wherein the assembly is adapted to perform dialing using the keys and bidirectional communication with a desired partner by transmitting and receiving signals between a body of the portable apparatus and the handset body using the short-distance communication means.

2. The assembly as claimed in claim 1, wherein the dialing comprises text transmission.

3. The assembly as claimed in claim 1, wherein the short-distance communication means is a Bluetooth module that is positioned on a bottom surface of the handset body while being adjacent to the hinge device.

4. The assembly as claimed in claim 1, wherein the handset body has a microphone device and the handset folder has a speaker device.

5. The assembly as claimed in claim 1, wherein the handset body and the handset folder have a size that is smaller than the portable apparatus and have a ratio of horizontal and vertical dimensions of at least 1:2.

6. The assembly as claimed in claim 1, wherein the handset body has a first opening and closing groove continuously extending along lateral edges and a front edge of an upper surface thereof, and the handset folder has a second opening and closing groove continuously extending along lateral edges and a front edge of a bottom surface thereof.

7. The assembly as claimed in claim 6, wherein the first and second opening and closing grooves are positioned to face each other when the handset folder is completely folded on the handset body.

8. The assembly as claimed in claim 6, wherein the first and second opening and closing grooves are symmetric to each other.

9. A portable apparatus comprising:
a main housing;
a sliding or swing housing adapted to slide or swing while continuously facing the main housing;
a device for enabling a user to wear the main housing around the user's neck for wired or wireless communication; and
at least one earphone connected to the device via a wire and adapted to be worn in the user's ear, wherein
the portable apparatus is adapted to be selectively used in a short-distance wireless communication mode while being worn around the neck or in a wired communication mode while the earphone is worn in the ear.

10. The portable apparatus as claimed in claim 9, wherein the device comprises:
a first wire for enabling the user to wear the portable apparatus around the user's neck;
a second wire connected to the first wire and the earphone to transmit signals;
a third wire connected to the first wire to transmit signals from the earphone; and
a connector positioned on an end of the third wire and connected to the main housing.

11. The portable apparatus as claimed in claim 9, wherein the sliding or swing housing has a display device positioned on an upper surface thereof and a four-way key positioned adjacent to the display device for listening to audio fro the apparatus.

12. The portable apparatus as claimed in claim 11, wherein the audio is music.
